(19) United States
(12) Patent Application Publication
(10) Pub. No.: US 2014/0308481 A1
(43) Pub. Date: Oct. 16, 2014

(54) POROUS FLEXIBLE SHEET AND METHOD AND APPARATUS FOR MANUFACTURING SAME

(71) Applicants: CASIO ELECTRONICS MANUFACTURING CO., LTD., Iruma-shi (JP); CASIO COMPUTER CO., LTD., Tokyo (JP)

(72) Inventor: Satoshi MITSUI, Tokyo (JP)

(73) Assignees: CASIO ELECTRONICS MANUFACTURING CO., LTD., Iruma-shi (JP); CASIO COMPUTER CO., LTD., Tokyo (JP)

(21) Appl. No.: 14/250,241

(22) Filed: Apr. 10, 2014

(30) Foreign Application Priority Data
Apr. 16, 2013 (JP) 2013-085634

(51) Int. Cl. C08J 5/18; B01J 6/00; G03G 13/00

(52) U.S. Cl. CPC C08J 5/18; G03G 13/00; B01J 6/005; C08J 2367/02
USPC 428/159; 521/182; 430/97; 422/307

(57) ABSTRACT

A method for manufacturing a porous flexible sheet according to the present disclosure includes forming a layer that includes a mixture including thermoplastic resin particles and inorganic particles and thermally fusing the thermoplastic particles to each other and to the inorganic particles while keeping at least a part of clearances between the particles.

### CROSS-REFERENCE TO RELATED APPLICATION

This application claims the benefit of Japanese Patent Application No. 2013-085634, filed on Apr. 16, 2013, the entire disclosure of which is incorporated by reference herein.

### FIELD

The present disclosure relates to a porous flexible sheet and a method and an apparatus for manufacturing the same.

### BACKGROUND

Flexible sheets are used for a variety of purposes, one of which is as a label.

For example, Unexamined Japanese Patent Application Kokai Publication Nos. 2007-283745, 2010-184470, and 2011-107418 each have proposed a method for manufacturing a label comprising a flexible sheet. In the method, first, an electrostatic latent image is formed on a photosensitive drum; next, toner is supplied thereto to form a toner layer having a shape corresponding to the electrostatic latent image; then, the toner layer is transferred from the photosensitive drum to a releasable sheet, and heat and pressure are applied to the toner layer to change the toner layer into a form of a nonporous sheet.

However, properties such as texture and transparency required for flexible sheets vary depending on the purposes thereof. The above method using electrophotography is advantageous in terms of being suitable for manufacturing a flexible sheet on demand, with no need for a printing plate and a mold. The method can, however, usually manufacture only nonporous flexible sheets.

### SUMMARY

The present disclosure has been accomplished in view of the above circumstances. It is an object of the present disclosure to provide a porous flexible sheet suitable for on-demand manufacturing.

In order to solve the above problem and achieve the object, a porous flexible sheet according to the present disclosure and a method and an apparatus for manufacturing the sheet are structured as follows.

According to a first aspect of the present disclosure, there is provided a porous flexible sheet including a porous body comprising a thermoplastic resin and an inorganic particle supported on the porous body.

In addition, according to a second aspect of the present disclosure, there is provided a method for manufacturing a porous flexible sheet that includes forming a layer that comprises a mixture including a plurality of thermoplastic resin particles and inorganic particles, in which there is a clearance between the thermoplastic resin particles, and heating the layer such that the thermoplastic resin particles are thermally fused to each other and to the inorganic particles while keeping at least a part of the clearance.

Furthermore, according to a third aspect of the present disclosure, there is provided an apparatus for manufacturing a porous flexible sheet comprising a layer forming device for forming a layer that comprises a mixture including a plurality of thermoplastic resin particles and inorganic particles and includes clearances between the thermoplastic resin particles, and a heating device for heating the layer such that the thermoplastic resin particles are thermally fused to each other and to the inorganic particles while keeping at least a part of the clearances.

### BRIEF DESCRIPTION OF THE DRAWINGS

A more complete understanding of this application can be obtained when the following detailed description is considered in conjunction with the following drawings, in which:

FIG. 1 is a side view schematically depicting a porous flexible sheet according to an embodiment of the present disclosure;

FIG. 2 is a side view depicting an enlarged part of the porous flexible sheet depicted in FIG. 1;

FIG. 3 is a side view schematically depicting an example of a structure obtained by applying heat and pressure to a part of the porous flexible sheet of FIG. 1;

FIG. 4 is a side view schematically depicting a step in the manufacturing of the porous flexible sheet of FIG. 1;

FIG. 5 is a side view schematically depicting an example of a flexible sheet obtained when inorganic particles are omitted;

FIG. 6 is a view schematically depicting an example of a manufacturing apparatus usable for manufacturing the porous flexible sheet of FIG. 1;

FIG. 7 is a view schematically depicting an exemplary heating device usable in the manufacturing apparatus of FIG. 6;

FIG. 8 is a perspective view schematically depicting another exemplary heating device usable in the manufacturing apparatus of FIG. 6;

FIG. 9 is a microscopic photograph of a porous flexible sheet according to Example 2; and

FIG. 10 is a microscopic photograph of a flexible sheet according to Comparative Example 1.

### DETAILED DESCRIPTION

Embodiments of the present disclosure will be described in detail with reference to the drawings hereinbelow.

Elements exerting the same or similar functions are given the same reference numerals throughout all the drawings, and repetitive descriptions thereof are omitted. In addition, although a layer or a planar object that can be used alone may be called “film” or “sheet” depending on the thickness thereof, it shall be understood that these terms do not include the concept of thickness herein.

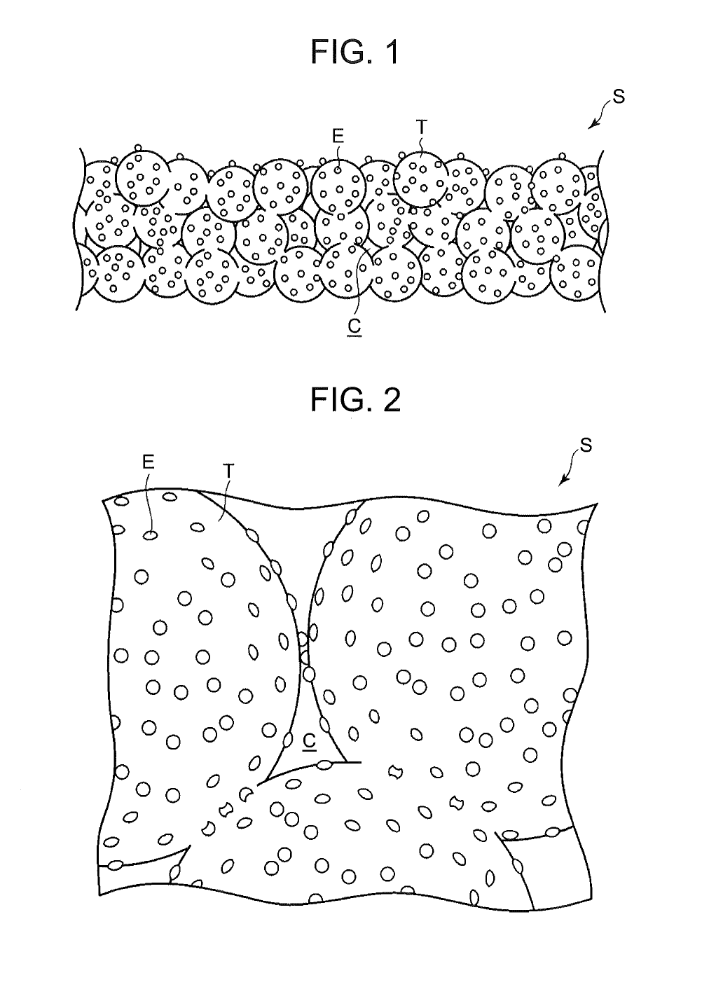

FIG. 1 is a side view schematically depicting a porous flexible sheet according to an embodiment of the present disclosure, and FIG. 2 is a side view depicting an enlarged part of the porous flexible sheet depicted in FIG. 1.

A porous flexible sheet S depicted in FIGS. 1 and 2 includes a thermoplastic resin T that forms a porous body and inorganic particles E supported on the porous body. The porous flexible sheet S is obtained by forming a layer that comprises a mixture including particles of the thermoplastic resin T and the inorganic particles E and causing a thermal fusion of the particles of the thermoplastic resin T to each other and to the inorganic particles E while keeping at least a part of clearances C between the particles, as will be described later. The thermal fusion integrates the thermoplastic resin T with the inorganic particles E. In the porous flexible sheet S, typically, the particles of the thermoplastic resin T are fused to each other while retaining a shape close to particle. Normally, the respective shapes and sizes of clearances C differ before and after thermal fusion.

The porous flexible sheet S has a porosity, for example, ranging from 20 to 70%, and typically ranging from 40 to 60%. When the porosity of the porous flexible sheet S is low, effects derived from being porous may not be clearly obtained, whereas when the porosity of the sheet S is high, the sheet may have insufficient strength.

The porous flexible sheet S has a thickness, for example, ranging from 90 to 350 μm, and typically ranging from 120 to 280 μm. A porous flexible sheet S with small thickness may have insufficient strength, whereas a porous flexible sheet S with large thickness may have low flexibility.

The porous flexible sheet S has a ratio of a volume VE of the inorganic particles E to a volume VT of the thermoplastic resin T (VE/VT), for example, ranging from 1.6×10⁻³ to 2.9×10⁻², and typically 5.7×10⁻³ to 1.1×10⁻². The term “volume” used herein does not mean an apparent volume including a clearance C but a solid volume including no clearance C. When the ratio VE/VT is set to be small, it is difficult to make the flexible sheet S porous, whereas when the ratio VE/VT is set to be large, flexibility is reduced.

The thermoplastic resin T is a thermoplastic resin commonly used for films. Such a thermoplastic resin typically has a low glass transition temperature (Tg). The glass transition temperature is, for example, less than 0° C. In order to pulverize the thermoplastic resin having the low glass transition temperature, freeze-pulverization is preferably used.

The softening point of the thermoplastic resin T is not particularly limited as long as the glass transition temperature satisfies the above condition. Typically, the softening point thereof is from 95 to 145° C.

Examples of the thermoplastic resin T usable include polybutylene succinate-based resins, polyethylene-based resins, polypropylene-based resins, and crystalline polyester-based resins.

The porous body can further include other ingredients such as an electrification controlling agent, a wax, or a coloring agent.

The electrification controlling agent is used, for example, to manufacture the porous flexible sheet S using electrophotography. In other words, when the porous body comprises toner particles, the toner particles usually further include an electrification controlling agent, in addition to the thermoplastic resin T.

The use of an electrification controlling agent allows the adjustments of an amount of electrification of toner and an electrification rate of the toner. The electrification controlling agent can be an arbitrary one that is usually used as an electrophotographic toner. In addition, A ratio of an amount of the electrification controlling agent to an amount of the thermoplastic resin T can be the same as that in ordinary film toners.

A wax can be used for release effect and the stabilization of thermal properties. The wax is not particularly limited and examples of the wax include an ester-based carnauba wax, a polypropylene wax, a polyethylene wax, and a Sasol wax.

The use of a coloring agent allows the coloring of the porous flexible sheet S. Thus, with the use of a coloring agent, a monochromatic image, a multicolor image, a gradation image, and the like can be indicated on the porous flexible sheet S. A ratio of an amount of the coloring agent to an amount of the thermoplastic resin T can be the same as that in ordinary film toners.

For example, in a case of a black-based coloring agent, carbon black is most suitable. Other examples of the black-based coloring agent usable include organic black dyes and pigments. If the coloring agent is white-based, titanium oxide as a white pigment is preferably used. Examples of other white coloring agents usable include silica and cerium oxide. Preferred is titanium oxide in terms of coloring power, cost, and handleability.

Examples of coloring agents usable for magenta color include quinacridone-based, naphthol-based, and calcium lake-based organic pigments and rhodamine-based organic dyes.

Coloring agents suitable for cyan color are organic pigments such as copper phthalocyanine. Other examples for cyan color include aluminum phthalocyanine-based pigments and blue dyes.

Examples of coloring agents usable for yellow color include monoazo-based, disazo-based, isoindolinone-based, benzimidazolone-based organic pigments, organic dyes and inorganic pigments such as bismuth vanadium oxide.

In addition, as for metallic colors, metallic luster color pigments are used. Examples thereof include pearl pigments prepared by coating mica, silica, alumina, or boron silicate glass with a metal oxide such as titanium oxide.

Examples of coloring agents usable for fluorescent colors include melamine-based organic fluorescent agents and inorganic fluorescent agents prepared by doping metals such as europium, manganese, terbium, and zinc in various ceramics.

In the manufacturing of the porous flexible sheet S using electrophotography, the toner particles have an average particle diameter of, for example, from 20 to 60 μm, and typically from 25 to 50 μm. The term “average particle diameter” used herein means a volume-average particle diameter (D50) obtained by flow type image analysis. When the average particle diameter of the toner particles is made small, an average diameter of the clearances C between the porous bodies becomes also small. Accordingly, when the average particle diameter of the toner particles is made excessively small, it is difficult to make the flexible sheet S porous. Conversely, when the average particle diameter thereof is made excessively large, the use of electrophotography itself becomes difficult. In the porous flexible sheet S manufactured using electrophotography, when the thermoplastic resin T remains in the shapes close to particles and is in a state of interparticle fusion, the average particle diameter of the thermoplastic resin T is substantially the same as that of the toner particles.

In order to add an electrification controlling agent, a wax, and a coloring agent to the thermoplastic resin T for preparing toner particles, an ordinary equipment for obtaining toner can be used other than using a pulverizer of freeze-pulverization type in the above-described pulverization step. For example, a Henschel mixer can be used for mixing and external additive, and a biaxial kneading machine (such as PCM) can be used for thermal melting and kneading. Freeze-pulverization is facilitated by passing kneaded strands through a water bath from a die outlet to cool and then pelletizing the cooled strands with a pelletizer or the like. The ordinary equipment for obtaining toner is not particularly limited as long as a pulverized toner can be used as an intended film toner. It is also possible to control an intended particle diameter using an air flow classification equipment as needed.

The inorganic particles E serve to prevent the particles of the thermoplastic resin T from being completely fused to each other in the process for manufacturing the porous flexible sheet S. In other words, the inorganic particles E serve to restrict the fusion of the thermoplastic resin T so as to keep the clearances C.

Examples of the inorganic particles E usable include particles comprising an inorganic oxide such as silica, alumina, or titania. For example, the inorganic particles E may be hydrophobicized by performing surface-treatment with silicone or a silane coupling agent.

The inorganic particles E have an average particle diameter of, for example, from 0.02 to 0.1 μm, and typically from 0.03 to 0.08 μm. The term “average particle diameter” used herein means a volume-average particle diameter (D50) obtained by the method mentioned regarding the toner particles. When the average particle diameter of the inorganic particles E is excessively small, it is difficult to make the flexible sheet S porous, whereas when the average particle diameter thereof is excessively large, the strength of the flexile sheet S is reduced.

There are two purposes of attaching the inorganic particles E to surfaces of the particles of the thermoplastic resin T: one is to provide heat-resistant properties controlling porosity for the thermal fusion described above, and the second is to provide electrification properties and fluidity properties for toner printing. The inorganic particles E are not easily detached since the particles are buried in the particle surfaces of the thermoplastic resin T or firmly attached to the resin particle surfaces by electrostatic or Van der Waals forces.

As a tool for attaching the inorganic particles E to the particle surfaces of the thermoplastic resin T, an ordinary toner external additive equipment can be used. For example, the particles of the thermoplastic resin T and the inorganic particles E are simultaneously mixed together by a Henschel mixer or the like, whereby the inorganic particles E can be brought in a state of being firmly attached onto the particle surfaces of the thermoplastic resin T.

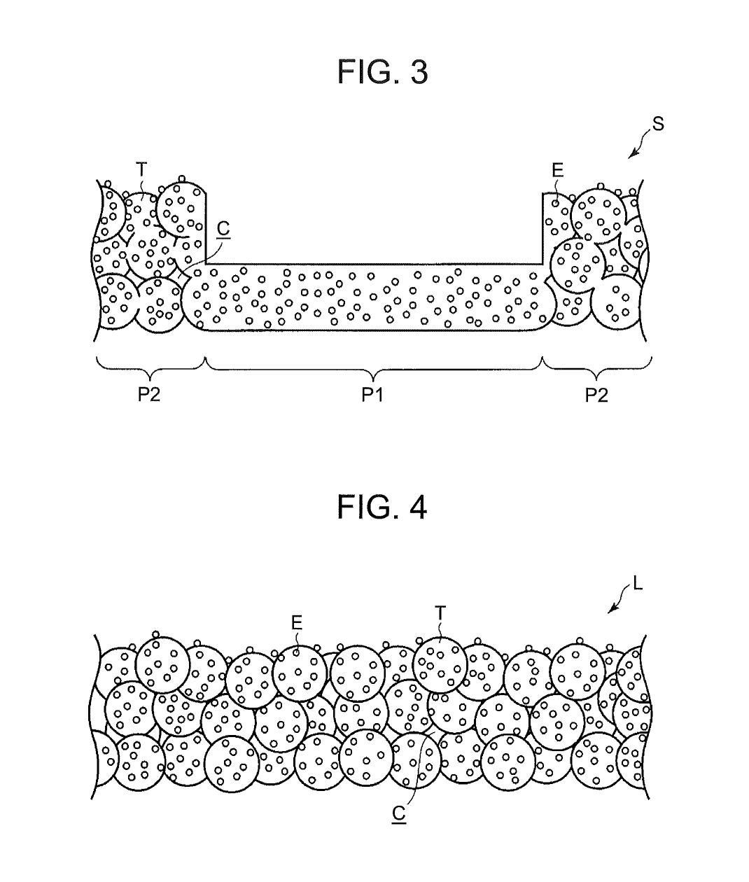

FIG. 3 is a side view schematically depicting an example of a structure obtained by applying heat and pressure to a part of the porous flexible sheet of FIG. 1.

The porous flexible sheet S depicted in FIG. 3 includes a first portion P1 and a second portion P2. This porous flexible sheet S can be obtained, for example, by pressing a part of the porous flexible sheet S of FIG. 1, namely, by applying heat and pressure to the part thereof. The first portion P1 corresponds to the pressed part, and the second portion P2 corresponds to an unpressed part.

The first portion P1 is the same as the second portion P2, except for the following points, namely: the first portion P1 is recessed with respect to the second portion P2 and has a smaller thickness and less porosity than the second portion P2. The first portion P1 may or may not include clearance. The second portion P2 has a surface shape reflecting the particle shape, whereas the first portion has a surface shape that has been flattened or on which a concave and convex pattern on a presser has been transferred as a result of pressing.

The second portion P2 has a larger thickness and greater porosity than the first portion P1. The second portion P2 is of the same structure as that of the porous flexible sheet S described with reference to FIGS. 1 and 2.

The first portion P1 has less porosity than the second portion P2 and therefore exhibits a lower light scattering performance than the second portion P2. In addition, while the surface of the first portion P1 is shaped by pressing, the surface of the second portion P2 has the shape reflecting the particle shape. Additionally, the surface of the first portion P1 is lower in height than that of the second portion P2. In other words, the first portion P1 is recessed with respect to the second portion P2, as described above. Accordingly, the first portion P1 and the second portion P2 can be distinguished from each other by naked-eye observation. Thus, the porous flexible sheet S depicted in FIG. 3 can indicate an image having a shape corresponding to the first portion P1 or the second portion P2.

The porous flexible sheets S described above can be used for a variety of purposes. For example, the porous flexible sheets S are usable as coasters, wrapping sheets, anti-slipping sheets, materials for clothing and accessories, and tags. In addition, the porous flexible sheets S can also be used as adhesive labels by providing an adhesive layer on one surface of the sheets.

Next, a description will be given of a method for manufacturing the porous flexible sheet S depicted in FIG. 1.

FIG. 4 is a side view schematically depicting a step in the manufacturing of the porous flexible sheet S of FIG. 1.

In order to manufacture the porous flexible sheet S, first, a layer L is formed. A layer L comprises a mixture including particles of the thermoplastic resin T and the inorganic particles E and includes the clearances C between the particles. The layer L can also be formed by a method other than electrophotography. However, in the case of using electrophotography, the layer L can be easily formed into an arbitrary shape on demand. In this case, it is also easy to form not only a layer L indicating a monochromatic image but also layers L indicating a multicolor image, a gradation image, and the like. Furthermore, the use of electrophotography facilitates the formation of the layer L with the clearances C between the particles.

Next, the layer L is heated, for example, non-contact heated such that the particles of the thermoplastic resin T are thermally fused to each other and to the inorganic particles E while keeping at least a part of the clearances C. As used herein, being “non-contact heated” means being heated by conducting heat to the layer L through radiation, convection, or both thereof without applying any pressure to the layer L. Non-contact heating can be performed, for example, using a ceramic heater, a halogen heater, or an oven. Normally, the respective shapes and sizes of clearances C differ before and after heating.

In the non-contact heating, the layer L is heated to substantially the same temperature or a higher temperature than the softening point of the thermoplastic resin T so that the thermal fusion described above occurs. Meanwhile, as the thermal fusion excessively progresses, interparticle clearances are reduced. Thus, the difference between the heating temperature and the softening point of the thermoplastic resin T is preferably 50° C. or less.

In addition, heating time may also affect the progress of the thermal fusion. When the heating time is short, thermal fusion cannot be sufficiently performed, whereas the heating time is long, thermal fusion excessively progresses and thereby the interparticle clearances C may be reduced. The heating time is, for example, set to be in a range of from 120 to 300 seconds.

As described above, the inorganic particles E serve to prevent the particles of the thermoplastic resin T from being completely fused to each other. In other words, when the inorganic particles E are omitted, there is a possibility that the particles of the thermoplastic resin T are completely fused to each other.

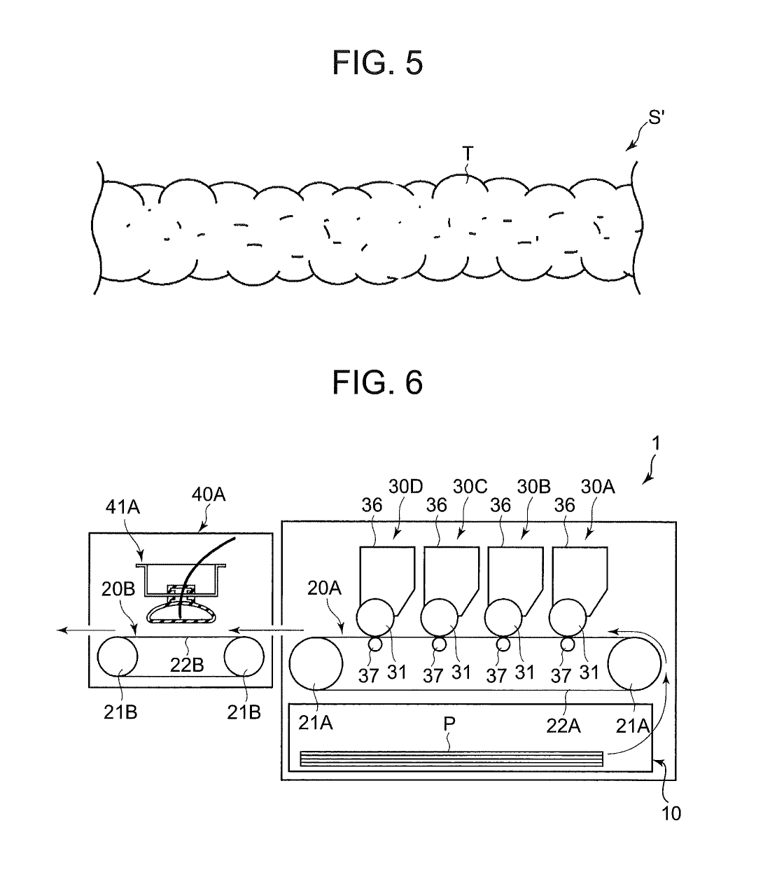

FIG. 5 schematically depicts an example of a flexible sheet obtained when the inorganic particles are omitted. As depicted in FIG. 5, the omission of the inorganic particles E leads to substantial elimination of the clearances C, as a result of which the particles of the thermoplastic resin T are almost completely fused to each other.

Next, a description will be given an apparatus for manufacturing the porous flexible sheet S of FIG. 1.

FIG. 6 is a view schematically depicting an example of a manufacturing apparatus usable for the manufacturing of the porous flexible sheet S of FIG. 1.

A manufacturing apparatus 1 depicted in FIG. 6 includes a releasable sheet supplier 10, conveyor mechanisms 20A and 20B, image formation units 30A to 30D, and a heating device 40A.

The releasable sheet supplier 10 supplies a releasable sheet P onto a belt 22A of the conveyor mechanism 20A.

The releasable sheet P to be used is a sheet that has a low surface energy and an excellent releasability, and examples of the sheet usable include sheets of paper or resin film ordinarily used as releasable sheets. The releasable sheet P can be repeatedly used and is typically of film type. Releasable sheets of film type have a higher durability than sheets of paper type and thus are durable even when repeatedly used a greater number of times.

The conveyor mechanism 20A includes a plurality of drive rollers 21A and the belt (endless belt) 22A laid across the drive rollers 21A and transfer rollers 37 that will be described later. The conveyor mechanism 20A receives the releasable sheet P from the releasable sheet supplier 10, conveys the sheet P sequentially to the front of each of the image formation units 30A to 30D, and then sends the sheet P out to the conveyor mechanism 20B.

The image formation units 30A to 30D serve as a layer forming device. The layer forming device forms, on the releasable sheet P conveyed to the front of the layer forming device by the belt 22A, a layer that comprises a mixture including toner particles containing the thermoplastic resin T as a main ingredient and the inorganic particles E and includes the clearances C between the particles.

Each of the image formation units 30A to 30D is provided with a photosensitive drum 31 having a photosensitive layer formed on a surface thereof, doctor blades (not shown) arranged in such a manner as to surround a circumferential surface of the photosensitive drum 31 in a circumferential direction thereof, an electrification roller (not shown), an exposure head (not shown) comprising an LED head, a developing roller (not shown), tank 36 filled with the mixture including the toner particles and the inorganic particles E and supplying the mixture to the developing roller, and the transfer roller 37 sandwiching the releasable sheet P and the belt 22 between the rollers and the photosensitive drums 31 and transferring the mixture on the releasable sheet P.

Typically, the tanks 36 of the image units 30A to 30D are filled with mixtures including different color toner particles. For example, the respective tanks 36 of the image formation units 30A, 30B, and 30C may be filled with a mixture including magenta toner particles, a mixture including cyan toner particles, and a mixture including yellow toner particles, respectively, whereas the tank 36 of the image formation unit 30D may be filled with a mixture including colorless and transparent or achromatic toner particles. Alternatively, the tanks 36 of the image formation unit 30A may be filled with colorless and transparent or achromatic toner particles, whereas the respective tanks 36 of the image formation units 30B, 30C, and 30D may be filled with a mixture including magenta toner particles, a mixture including cyan toner particles, and a mixture including yellow toner particles, respectively.

A layer comprising the mixture including the colorless and transparent or achromatic toner particles, a layer comprising the mixture including the magenta toner particles, a layer comprising the mixture including the cyan toner particles, and a layer comprising the mixture including the yellow toner particles can be transferred in such a manner that the layers overlap each other on the releasable sheet P. In the other words, the layer formed on the releasable sheet P by the layer forming device may be of a single layer structure or a multi-layer structure.

The conveyor mechanism 20B includes a plurality of drive rollers 21B and a belt (endless belt) 22B laid across the drive rollers 21B. The conveyor mechanism 20B receives the releasable sheet P from the conveyor mechanism 20A and conveys the sheet in the heating device 40A.

The heating device 40A performs non-contact heating of the layer L such that the toner particles are thermally fused to each other and to the inorganic particles E while keeping at least a part of the clearances C, thereby obtaining the porous flexible sheet S.

Herein, the heating device 40A includes a ceramic heater as a heater 41A. The heater 41A is arranged so as to face the releasable sheet P conveyed by the conveyor mechanism 20B.

In order to manufacture the porous flexible sheet S depicted in FIG. 3, for example, a not-shown pressing device may be arranged on a rear stage of the heating device 40A to perform pressing on the porous flexible sheet S on that stage.

The pressing device may be arranged between the layer forming device and the heating device 40A, although this arrangement easily causes the adhesion of the thermoplastic resin particles T and the like to the presser.

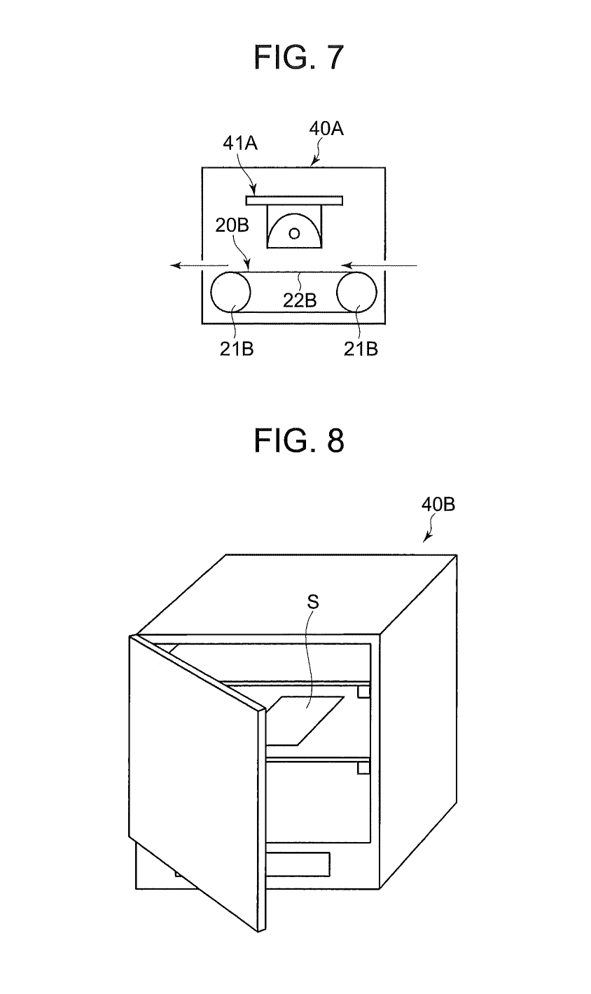

The heater 41A may not necessarily be a ceramic heater and, for example, may be a halogen heater 41A depicted in FIG. 7. Additionally, instead of the heating device 40A including the heater 41A, an oven 40B depicted in FIG. 8 may be used as the heating device.

While the above description has been given of the manufacturing of the porous flexible sheet S using electrophotography, the porous flexible sheet S can also be manufactured by other methods. For example, first, a slurry is prepared that includes particles of the thermoplastic resin T (hereinafter referred to as thermoplastic resin particles) and the inorganic particles E. Then, the slurry is applied onto a support member such as a releasable sheet to form a coating film. Next, the coating film is dried in such a manner as not to cause fusion between the thermoplastic resin particles to form a layer that comprises a mixture including the thermoplastic resin particles and the inorganic particles E and includes the clearances C between the particles. Then, the layer is heated, for example, non-contact heated such that the thermoplastic resin particles are thermally fused to each other and to the inorganic particles E while keeping at least a part of the clearances C.

### EXAMPLES

### Example 1

A polybutylene succinate-based resin “GS Pla®” manufactured by Mitsubishi Chemical Corporation was frozen with liquid nitrogen and pulverized to a particle diameter enough for particles to pass through a 75 μm filter by a Linrex Mill manufactured by Hosokawa Micron Corporation. The powder thus obtained is hereinafter referred to as “resin powder”.

The volume-average particle diameter (D50) of the resin powder was measured. Specifically, a small amount of the resin powder, together with purified water and a surfactant, was placed in a beaker and ultrasonically stirred to prepare a sample. The sample was then analyzed by a flow type particle image analyzer “FPIA-2100” manufactured by Sysmex Corporation. As a result, the resin powder was found to have a volume-average particle diameter (D50) of 48 μm.

In addition, the softening point of the resin powder was measured. Specifically, 1 g of the resin powder was used as a sample and analyzed by a flow tester “CFT-500D” manufactured by Shimadzu Corporation. Herein, analysis was made at a temperature increase rate of 6° C./min under a load of 20 kg using a nozzle with a diameter of 1 mm and a length of 1 mm. Then, the softening point of the resin powder was obtained by a ½ method. Specifically, a temperature at which a half of the sample flew out was regarded as a softening point. As a result, the resin powder was found to have a softening point of 125° C.

Next, 100 pts. mass of the resin powder and 1.5 pts. mass of silica “RY50”, which is a hydrophobic silica, manufactured by Nippon Aerosil Co., Ltd., were mixed together by a Henschel mixer. A powder thus obtained was filled in the tank 36 of the image formation unit 30A of the manufacturing apparatus 1 depicted in FIG. 6 to form a layer L comprising the powder on the releasable sheet P. Here, the layer L was not heated by the heating device 40A.

Then, the layer L on the releasable sheet P was placed in the oven 40B depicted in FIG. 8 and heated at 105° C. for 3 minutes.

After the heating, the thickness of the layer L was measured by a micro meter. As a result, the layer L after the heating was found to have a thickness of approximately 180 μm.

In addition, evaluation was made on molten state, porosity, and strength of the layer L after the heating.

As for the molten state, the layer L was microscopically observed and the observation results were evaluated based on the following grade scale:

A: Each of the thermoplastic resin particles melt and bound to any other particle.

B: Only a part of the thermoplastic resin particles melt and bound to any other particle.

C: Each of the thermoplastic resin particles does not melt.

As for the porosity, the layer L was microscopically observed and the observation results were evaluated based on the following grade scale:

A: Each of the thermoplastic resin particles retains a particle shape.

B: Each of the thermoplastic resin particles is slightly deformed out of shape and clearances are partially closed.

C: Each of the thermoplastic resin particles has lost the particle shape and the layer L is a solid sheet.

The strength was evaluated based on the following grade scale:

A: The layer L retains the shape of sheet even when touched by hand after having been separated from the releasable sheet.

C: The layer L is torn off or disintegrated into powder when touched by hand.

In addition, the layers L were formed, heated, and then evaluated in the same manner as described above except for changing the heating temperature to 110° C., 115° C., 120° C., 125° C., and 130° C.

The results are summarized in Table 1 below.

Additionally, the layer L was formed and heated in an oven in the same manner as Example 1 except for using a powder instead of the resin powder prepared by melt-kneading the polybutylene succinate-based resin “GS Pla®” manufactured by Mitsubishi Chemical Corporation, an electrification controlling agent in an amount of 1% by mass with respect to the resin, and a wax in an amount of 2% by mass with respect to the resin and freeze-pulverizing the melt-kneaded mixture in the same manner as the resin powder. Then, the molten state, porosity, and strength of the layer L after the heating were evaluated. As a result, the same results as Example 1 were obtained.

### Example 2

An amount of 100 pts. mass of the resin powder and 1.5 pts. mass of the silica “RY50”, which is a hydrophobic silica, manufactured by Nippon Aerosil Co., Ltd., were dispersed in a dispersion medium containing water and isopropanol in a volume ratio of 70:30 and furthermore a very small amount of a surfactant. Then, a frame was disposed on a releasable sheet and the resulting dispersion medium was supplied in the frame. The amount of the dispersion medium supplied was adjusted such that the amounts of the resin powder and the hydrophobic silica per unit area were the same as those in Example 1. Next, the resulting sheet was dried by heating in an oven with a temperature of 60° C. for 30 minutes, whereby a layer L comprising the powder was formed on the releasable sheet.

A plurality of layers L were formed in the above manner and heated under the different temperature conditions, as in Example 1. Then, regarding the layers L after the heating, evaluation was made on molten states, porosities, and strengths, as in Example 1. The results are summarized in Table 1 below.

### Example 3

The preparation of a dispersion solution, the supply of the dispersion solution in a frame, and drying were performed in the same manner as Example 2 except for changing the amount of the hydrophobic silica to 1.0 part by mass with respect to 100 pts. mass of the resin powder, thereby forming a plurality of layers L comprising the powder. Next, the layers L were heated under the different temperature conditions, as in Example 1. Then, regarding the layers L after the heating, evaluation was made on molten states, porosities, and strengths, as in Example 1. The results are summarized in Table 1 below.

### Comparative Example 1

The preparation of a dispersion solution, the supply of the solution in a frame, and drying were performed in the same manner as Example 2 except for omitting the hydrophobic silica, thereby forming a plurality of layers L comprising the powder. Then, the layers L were heated under the different temperature conditions, as in Example 1. Then, regarding the layers L after the heating, evaluation was made on molten states, porosities, and strengths, as in Example 1. The results are summarized in Table 1 below.

### Comparative Example 2

The preparation of a dispersion solution, the supply of the solution in a frame, and drying were performed in the same manner as Example 2 except for changing the amount of the hydrophobic silica to 0.5 pts. mass with respect to 100 pts. mass of the resin powder, thereby forming a plurality of layers L comprising the powder. Then, the layers L were heated under the different temperature conditions, as in Example 1. Then, regarding the layers L after the heating, evaluation was made on molten states, porosities, and strengths, as in Example 1. The results are summarized in Table 1 below.

TABLE 1

| | | | | | Comparative | Comparative |
|---|---|---|---|---|---|---|
| | | Example 1 | Example 2 | Example 3 | Example 1 | Example 2 |
| Layer forming | | Electrophotography | Application of | Application of | Application of | Application of |
| method | | | dispersion | dispersion | dispersion | dispersion |
| | | | solution | solution | solution | solution |
| Inorganic particles | | 1.5 pts. mass | 1.5 pts. mass | 1.0 part by mass | None | 0.5 pts. mass |
| Evaluation items | | Molten state/ | Molten state/ | Molten state/ | Molten state/ | Molten state/ |
| | | porosity/strength | porosity/strength | porosity/strength | porosity/strength | porosity/strength |
| Heating | 105 | C/A/C | C/A/C | C/A/C | C/A/C | C/A/C |
| temperatures | 110 | C/A/C | C/A/C | C/A/C | B/B/C | B/A/C |
| (° C.) | 115 | C/A/C | C/A/C | C/A/C | B/B/C | B/B/C |
| | 120 | A/A/A | A/A/A | A/B/A | A/C/A^{*1)} | A/C/A^{*1)} |
| | 125 | A/A/A | A/A/A | A/B/A | A/C/A | A/C/A |
| | 130 | A/A/A | A/A/A | A/B/A | A/C/A | A/C/A |

^{*1)}Through-holes were sporadically present.

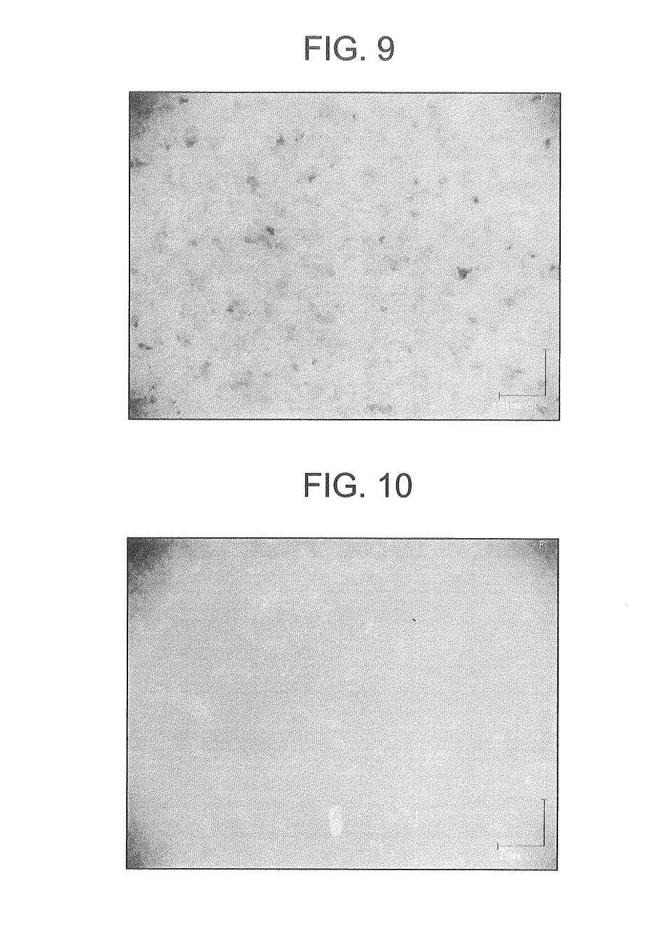

In addition, FIG. 9 depicts a microscopic photograph of a sheet obtained when the heating temperature was 120° C. or higher as in Example 2, and FIG. 10 depicts a microscopic photograph of a sheet obtained when the heating temperature was 120° C. or higher as in Comparative Example 1.

As shown in Table 1, when the heating temperature was 120° C. or higher in Examples 1 and 2, all of the molten states, the porosities, and the strengths had particularly excellent results. The layers L after the heating, namely, porous flexible sheets S, obtained in Examples 1 and 2 had high flexibility. The layers L also had a same texture.

The manufacturing method according to Example 1 is the same as the manufacturing method according to Example 2 except that the former formed the layer L using electrophotography and the latter formed the layer L from the dispersion solution. Accordingly, it can be found that the properties of a final product are not significantly affected by a selection on whether the layer L is formed using electrophotography or formed from a dispersion solution.

In a comparison among the layers heated to 120° C. or higher in the results of Examples 2 and 3, Example 3 had the layers L in which the thermoplastic resin particles were slightly deformed out of shape and clearances were partially closed, as compared to Example 2. The porous flexible sheet S obtained in Example 3 had a lower flexibility and a less soft texture than the porous flexible sheets S obtained in Examples 1 and 2. The reason for this seems to be that Example 3 was less effective in inhibiting the fusion between the thermoplastic resin particles due to the less amount of the hydrophobic silica as compared to Example 2.

When the heating temperature was 120° C. or higher in Comparative Examples 1 and 2, the obtained sheets were not porous but solid. A comparison between Example 2 and Comparative Example 1 shows that a sufficient amount of inorganic particles are essential to obtain a porous flexible sheet.

Porosities were measured for the sheets obtained in Examples 1 to 3 and Comparative Examples 1 and 2. As a result, sheets given a porosity evaluation of “A” had a porosity of 40% or more; sheets given a porosity evaluation of “B” had a porosity of 20% or more and less than 40%; and sheets given a porosity evaluation of “C” had a porosity of less than 20%.

Furthermore, it is obvious that various modifications can be made within the scope of the disclosure.

Having described and illustrated the principles of this application by reference to one preferred embodiment, it should be apparent that the preferred embodiment may be modified in arrangement and detail without departing from the principles disclosed herein and that it is intended that the application be construed as including all such modifications and variations insofar as they come within the spirit and scope of the subject matter disclosed herein.

What is claimed is:

1. A method for manufacturing a porous flexible sheet comprising:
forming a layer that comprises a mixture including a plurality of thermoplastic resin particles and inorganic particles and includes clearances between the thermoplastic resin particles; and
heating the layer such that the thermoplastic resin particles are thermally fused to each other and to the inorganic particles while keeping at least a part of the clearances.

2. The method for manufacturing a porous flexible sheet according to claim 1, wherein the layer is non-contact heated.

3. The method for manufacturing a porous flexible sheet according to claim 2, further comprising applying heat and pressure to a part of the non-contact heated layer to reduce a thickness and a porosity of the part.

4. The method for manufacturing a porous flexible sheet according to claim 1, wherein the layer is formed by electrophotography.

5. The method for manufacturing a porous flexible sheet according to claim 1, wherein the inorganic particles are mixed in an amount of from 1.0 to 1.5 pts. mass with respect to 100 pts. mass of the thermoplastic resin particles.

6. An apparatus for manufacturing a porous flexible sheet comprising:
a layer forming device for forming a layer that comprises a mixture including a plurality of thermoplastic resin particles and inorganic particles and includes clearances between the thermoplastic resin particles; and
a heating device for heating the layer such that the thermoplastic resin particles are thermally fused to each other and to the inorganic particles while keeping at least a part of the clearances.

7. The apparatus for manufacturing a porous flexible sheet according to claim 6, wherein the heating device performs non-contact heating of the layer.

8. The apparatus for manufacturing a porous flexible sheet according to claim 7, further comprising an embossing device for applying heat and pressure to a part of the non-contact heated layer to reduce a thickness and a porosity of the part.

9. The apparatus for manufacturing a porous flexible sheet according to claim 6, wherein the layer is formed by electrophotography.

10. A porous flexible sheet formed by the method for manufacturing a porous flexible sheet according to claim 1, including a porous body comprising the thermoplastic resin and the inorganic particles supported on the porous body.

11. The porous flexible sheet formed by the method for manufacturing a porous flexible sheet according to claim 10, comprising a first portion as a part of the porous flexible sheet and a second portion as another part of the porous flexible sheet, wherein the first portion is recessed with respect to the second portion and has a smaller porosity than the second portion.
